(19) United States
(12) Patent Application Publication
(10) Pub. No.: US 2012/0189146 A1
(43) Pub. Date: Jul. 26, 2012

(54) CONTACTLESS RECHARGING OF THE BATTERY OF A PORTABLE OBJECT BY A TELEPHONE

(75) Inventor: Luc Wuidart, Pourrieres (FR)

(73) Assignee: STMICROELECTRONICS (ROUSSET) SAS, Rousset (FR)

(21) Appl. No.: 13/349,454

(22) Filed: Jan. 12, 2012

(30) Foreign Application Priority Data
Jan. 21, 2011 (FR) 11 50488

(51) Int. Cl. H04B 7/00; H04R 25/00; H04W 88/02; H02J 7/00

(52) U.S. Cl. 381/312; 320/108; 455/41.2; 455/550.1

(57) ABSTRACT

A method for charging the battery of a portable object by a telephone, comprising a step for contactless transmission of power from a charging device of the telephone to the portable object, inducing the charging of the battery of the portable object.

### BACKGROUND

1. Technical Field

The present document relates to a method for the contactless charging of a portable object, particularly suited to the charging of the battery powering a hearing aid, and a telephone/charger operating without contact as such implementing such a charging method. It also relates to a system comprising such a contactless charger and an object comprising a power supply battery to be charged.

2. Description of the Related Art

Many portable objects, such as a hearing aid or a Bluetooth ear piece for example, now operate autonomously using a power supply battery. It is common to exchange or recharge this battery when the energy has been drained in order to be able to continue using such a portable object.

A portable object may, for example, consist of a hearing aid, whose function is to assist in the hearing of its wearer, who has at least one defective ear. A hearing aid comprises, at the input, microphones for picking up its environment, a processing unit for, in particular, filtering and amplifying the useful signal, then a loudspeaker for transmitting this processed sound by making it audible to an individual whose ear is defective. This operation requires an electrical power supply, which is in particular demand since the user of the hearing aid wears it permanently in or on his ear and has a constant need for its assistance. Thus, the battery of a hearing aid discharges very rapidly.

The document EP1727395 proposes a solution to address this particular constraint, by avoiding the costly replacement of non-rechargeable hearing aid batteries. For this, it proposes a charging casing allowing for the positioning of two power supply batteries, which are recharged contactlessly via an electromagnetic field. This solution however retains the drawback of having to remove and then replace the batteries of the hearing aid very regularly. The user must also have a spare battery to use it while the other battery or batteries are in the charger in the recharging phase, if he desires permanent use of the hearing aid. These battery handling operations are not user-friendly, and risk causing deterioration to the hearing aid when opening its casing to exchange the battery. They also present the risk of battery loss because of the small battery size. Finally, they also risk inducing deterioration to the battery housing in case of bad positioning of the battery within this housing.

The document U.S. 2009/285426 presents another solution in which a hearing aid is equipped with an antenna used both for the transmission of data and of power. A specific charger is provided to contactlessly recharge the hearing aid, using an oscillating circuit corresponding to the resonant oscillating circuit within the hearing aid, linked to its battery so as to be able to recharge it. This solution avoids having to remove the battery from a hearing aid for it to be recharged but requires the hearing aid to be removed from the ear in order to place it on a placement of a charger when its battery is discharged. During this period, the hearing aid cannot be used. Furthermore, it is necessary to have a particular charger, dedicated to the hearing aid.

The document WO2010/108492 describes a solution in which a hearing aid communicates with a portable telephone via a short-range contactless communication, in order to use the hearing aid as an accessory of the telephone, making it possible to add extra functionalities to a telephone. This additional use of a hearing aid presents the drawback of further increasing the demand on the battery of the hearing aid and further reducing its autonomy, thus aggravating the issue explained previously.

There is a need for a solution for charging the battery of a portable object, such as a hearing aid, which does not include all or some of the drawbacks of the prior art.

More specifically, a desirable object is a solution for charging the battery of a portable object which is user-friendly, inexpensive and not bulky, which allows for a maximum time of use of the portable object.

### BRIEF SUMMARY

To this end, one embodiment of the disclosure relies on a method for charging a battery of a portable object by a telephone, comprising contactless or wireless transmission of power from a charging device of the telephone to the portable object, and inducing the charging of the battery of the portable object.

The method for charging the battery of a portable object may comprise the following steps:
emission of an electromagnetic field by the telephone;
resonance of a resonant circuit of the portable object inducing a charging current for the battery of the portable object.

The emission of an electromagnetic field by the telephone may be at a frequency of between 10 and 15 Megahertz (MHz).

The emission of an electromagnetic field by the telephone for the charging of a portable object may be done during a telephone call.

The emission of an electromagnetic field by the telephone for the charging of a portable object may be done largely during the reception phases during the telephone call.

The method for charging the battery of a portable object may comprise a step for contactless data exchange between the portable object and the telephone via the charging device of the telephone.

The step for contactless data exchange between the portable object and the telephone may comprise all or some of the following steps:
transmission of the state of charge of the battery from the portable object to the telephone;
transmission, from the portable object to the telephone, of data representing the state of health of the battery, such as ageing or deterioration;
transmission of data characteristic of the operation of the portable object to the telephone;
transmission of parameters for setting the operation of the portable object, such as updates for software, by the telephone.

The method for charging the battery of a portable object may also comprise a step for displaying on a screen of the telephone all or some of the following information:
the state of charge of the battery of the portable object;
the state of health of the battery of the portable object;
a datum representing the operation of the portable object;
a parameter for setting the operation of the portable object, such as the version of its software;
a mode of the telephone, such as a mode for charging the battery of a portable object.

The method for charging the battery of a portable object may relate to a hearing aid and may comprise the following steps during a telephone call:

a. detection by the telephone and the hearing aid of their proximity;

b. increase in the sound volume of the telephone and reduction of the amplification of the incoming sound by the hearing aid;

c. charging of the battery of the hearing aid by the telephone.

The disclosure also relates to a telephone comprising a wireless emission/reception device for conducting a telephone call, comprising a battery charging device and a computer which implements one of the methods for charging the battery of a portable object as defined previously.

The battery charging device may comprise a resonant circuit comprising an antenna.

The antenna of the resonant circuit of the battery charging device may occupy more than half of the surface area of the telephone.

The antenna of the resonant circuit of the battery charging device may be incorporated in a screen of the telephone.

The resonant frequency of the resonant circuit of the battery charging device of the telephone may be between 10 and 15 MHz and/or the resonant circuit may be suitable for a contactless transmission of power at a distance less than or equal to 10 centimeters.

The telephone may comprise a screen and a human-machine interface making it possible to communicate with a portable object via this screen.

The human-machine interface may make it possible to select a mode for managing the charging of the battery of a portable object.

The resonant circuit of the battery charging device of the telephone may be suitable for a data exchange with a portable object.

The disclosure also relates to a system comprising a hearing aid and a telephone, wherein the telephone is as described previously and wherein the hearing aid comprises a resonant circuit linked to its battery and substantially equals the resonant circuit of the charging device of the telephone, so as to be able to recharge its battery via a contactless transmission of power by the telephone.

The disclosure also relates to a system comprising a telephone and at least two different portable objects, characterized in that the telephone is as described previously and in that each portable object may comprise a resonant circuit linked to its battery and matched to the resonant circuit of the charging device of the telephone, so as to be able to recharge its battery via a contactless transmission of power by the telephone.

### BRIEF DESCRIPTION OF THE SEVERAL VIEWS OF THE DRAWINGS

Aspects of the present disclosure will be explained in detail in the following description of a particular embodiment, given as a non-limiting example, in relation to the appended figures in which:

FIG. 1 schematically represents a system comprising a hearing aid and a mobile telephone according to one embodiment of the disclosure.

FIG. 2 schematically represents the hearing aid according to one embodiment of the disclosure.

FIG. 3 schematically represents the telephone according to one embodiment of the disclosure.

FIG. 4 schematically represents another view of the telephone according to one embodiment of the disclosure.

FIG. 5 schematically represents a flow diagram of a method for charging a hearing aid according to an embodiment of the disclosure.

### DETAILED DESCRIPTION

One or more embodiments disclosed are directed to charging a battery of a portable object by a mobile telephone. This solution may offer one or more of the following advantages:
it does not require any specific charger dedicated to the portable object,
it makes it possible to use certain components that already exist in the telephone for a new application for the smart charging of the battery of a portable object, accompanied by complementary services, as will be detailed hereinbelow,
it makes it possible to charge a hearing aid during a telephone call, automatically and transparently for its wearer.

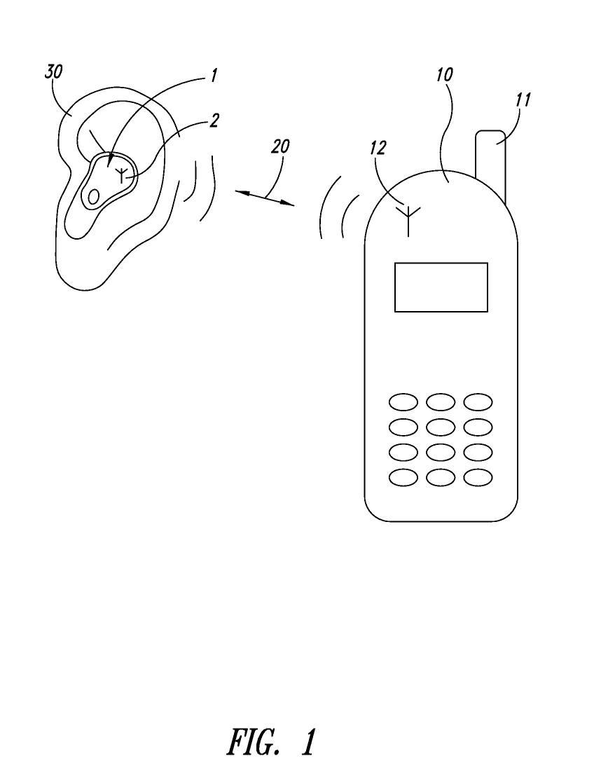

FIG. 1 represents a system according to an embodiment comprising a hearing aid 1 positioned in an ear 30 and a mobile telephone 10 equipped with a device for charging the hearing aid 1.

The hearing aid 1, more specifically represented in FIG. 2, is equipped with the usual components to fulfill a hearing aid function. Thus, it comprises at least one microphone 3, picking up the surrounding sound as input, a processing unit 4 comprising software and/or hardware means, such as a computer, for processing the incoming sound picked up by the microphone(s) 3, and transmitting a processed sound, notably a filtered and amplified sound, to the ear 30 of its wearer via a loudspeaker 5. Finally, the hearing aid 1 comprises a rechargeable battery 6 for its power supply, notably for the needs of the processing unit 4. It also comprises a resonant circuit 2 suitable for the contactless or wireless charging of its battery 6, as will be detailed hereinbelow. This resonant circuit 2 comprises an (inductance) antenna Ls and a capacitance Cs, thus forming an oscillating circuit that can start resonating at the chosen resonant frequency, according to the values of this inductance Ls and this capacitance Cs.

The mobile telephone 10 is equipped with the usual components for fulfilling the telephony function, allowing for a radio frequency telephone call according to the current standards by an antenna 11, such as the GSM, CDMA, EDGE, UMTS and other standards. In addition, the telephone is equipped with a battery charging device comprising a resonant circuit 12 suitable for charging the battery 6 of the hearing aid 1 via a contactless link 20, according to a battery charging method which will be detailed hereinbelow and at least partially implemented by a computing device of the telephone.

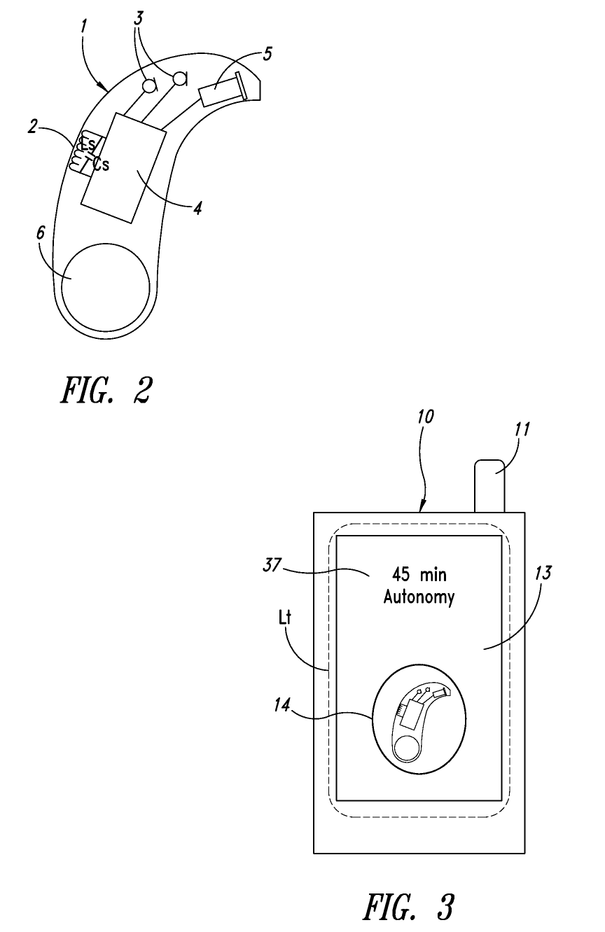

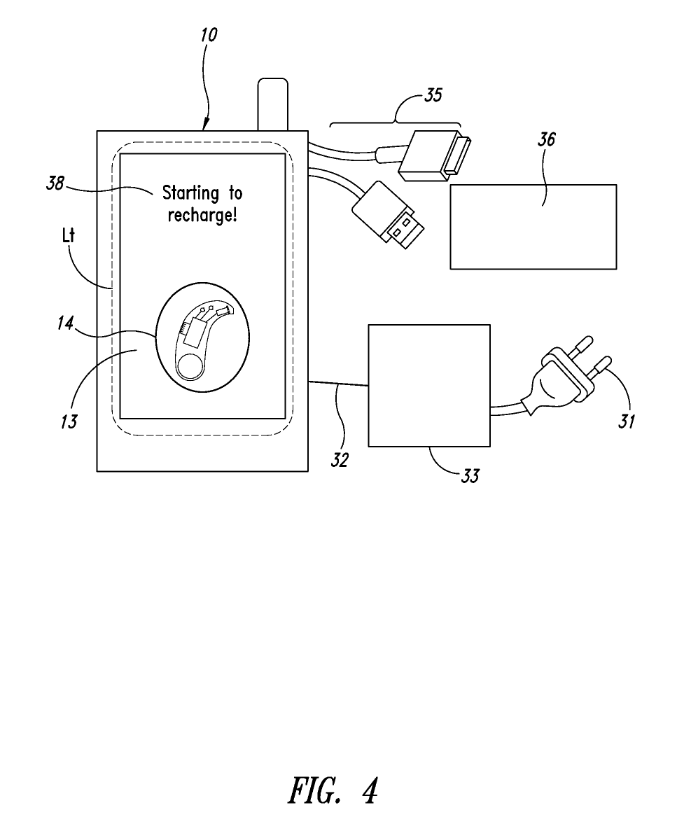

FIG. 3 represents a mobile telephone 10 according to one embodiment. Its charging device mainly comprises an (inductance Lt) antenna Lt and a capacitance, not represented, to form a circuit that oscillates according to a resonant frequency that corresponds to, such as substantially equals, or is a harmonic of, the resonant frequency of the resonant circuit 2 of the hearing aid 1, different from the frequency used for the telephone call via the antenna 11 of a particular geometrically suitable for long-range emissions and receptions at the frequency standardized for mobile telephone calls. On the other hand, the resonant circuit 12 of the telephone, and in particular its inductance antenna Lt, is designed for a short-range communication at a particular frequency distant from the telephone frequency. According to one embodiment, this antenna of the resonant circuit is incorporated around the screen 13 of the telephone and occupies a significant portion of its surface area. The antenna advantageously occupies at least half of the surface area of the telephone. As a variant, this antenna may be incorporated within the screen 13 of the telephone.

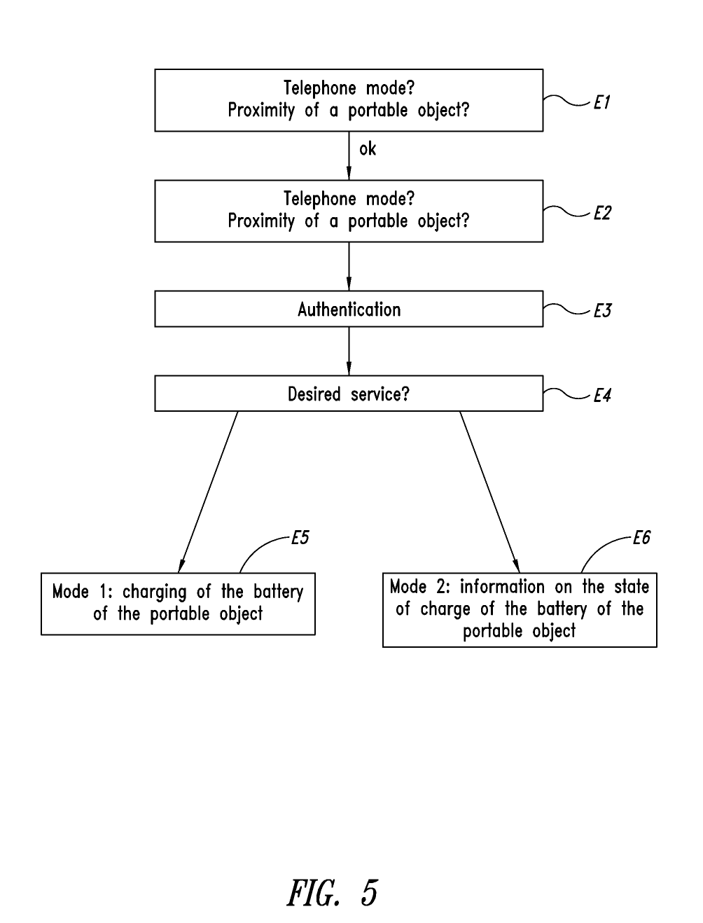

The resonant circuit 12 of the telephone 10 receives an electrical power supply so as to emit an electromagnetic field according to the predefined resonant frequency. This electrical power supply, as is schematically represented in FIG. 4, may originate from a battery of the telephone, shared by all the functions of the telephone or dedicated to the charger function, or from a link 32 from the telephone to an electrical mains supply 31 via its adapter 33, or from a link 35 with another distinct device 36 providing an electrical power supply to the telephone, such as a USB link with a computer, for example.

By this means, the resonant circuit 12 of the telephone 10 can emit an electromagnetic field via its resonant circuit of the battery charging device. The resonant circuit 2 of the hearing aid is matched to that of the telephone 10. Such an electromagnetic field created by a telephone 10 induces an electric current within the antenna Ls of the hearing aid 1, which is exploited for the charging of the battery 6 of the hearing aid 1. Thus, when the latter is positioned in the electromagnetic field of the telephone, it starts resonating and makes it possible to provide an electrical power supply for charging its battery, according to a so-called “contactless” or “wireless” remote power feed, unlike the links which require a physical electrical contact via an electrical connector.

According to this embodiment, the resonant circuits of the hearing aid and of the telephone have physical characteristics, notably their respective inductances and capacitances, so as to form oscillating circuits which resonate at substantially the same resonant frequency, in a radiofrequency domain. According to another embodiment, this radiofrequency corresponds to a communication according to the technology known as near-field communication (NFC). As a variant, it may comprise a short-distance contactless communication at a frequency of between 10 and 15 MHz, or with any inductive coupling, allowing for a contactless communication at a short distance, less than or equal to 10 centimeters.

The operation of this system will now be explained, using a method for charging the battery of the hearing aid according to one embodiment. Advantageously, this system makes it possible to charge the battery of the hearing aid while its wearer is engaged in a telephone call and naturally has his telephone close to his ear 30. In this way, the hearing aid positioned in that ear is at a short distance compatible with the contactless recharging of the battery that it contains, without its wearer being aware thereof, and therefore transparently for him. This functionality thus makes it possible to delay, or even totally avoid, a distinct hearing aid charging phase which would make the hearing aid unusable. The level of charge reached by the battery of the hearing aid naturally depends on the duration, on the frequency, and on the number of telephone calls made by the wearer of the hearing aid, and there will possibly have to be additional charges outside of a telephone call if necessary. The wearer of two hearing aids can advantageously use the telephone by positioning his telephone alternately in proximity to the right and left ears, in order to allow for the alternate recharging of his two hearing aids.

Advantageously, the telephone manages the combination of the two cumulative functions of telephone communication and contactless recharging of the hearing aid in an optimized and smart manner, using software and/or hardware devices within the telephone.

For this, a first advantageous solution may comprise implementing a charging phase for the hearing aid, that is to say, a phase for the emission of the charging electromagnetic field by the telephone, preferably when the telephone call is in a reception, and not emission, phase, to avoid interference and/or an accumulation of operations consuming computation and energy resources, notably to save on the battery of the telephone. Thus, the charging of the battery of the hearing aid will be done mostly, and if possible totally, during the reception phase of the telephone call.

Furthermore, a second advantageous solution which provides a response to the technical problem of saving the battery of the hearing aid comprises the one hand of a detection of the proximity of the telephone and of the hearing aid and, on the other hand, of an increase in the sound volume of the telephone, enabling the energy consumption of the hearing aid to be reduced since its need for amplification of the incoming sound is reduced: this function therefore reduces the energy consumption of the hearing aid and thus extends the period of use of the battery of the hearing aid between two charges.

It is worth noting that the contactless link 20 between the telephone 10 and the hearing aid 1 allows not only a contactless transmission of power for the recharging of the battery of the hearing aid, as has been described previously, but also the transfer of data in both directions between the hearing aid 1 and the telephone 10. This transfer of data enables the hearing aid to transmit information on the state of charge of its battery 6, as well as additional information concerning the state of health of its battery 6, that is to say, including information on its ageing and/or on any physical degradation, and data representing more generally the operation of the hearing aid 1. In return, the telephone 10 can transmit data to the hearing aid, for example parameters for setting its operation, updates for its sound processing software, and so on.

These data exchanged between the hearing aid 1 and the telephone 10 may be displayed on the screen 13 of the telephone in order to make it possible, for example, to inform a hearing aid wearer of the state of charge of its battery 6, by a message 37 as represented in FIG. 3. This screen 13 of the telephone 10 thus makes it possible to implement a human-machine interface between a user and the system, enabling this user to select services from a number of available services, such as the display of this message 37 on the state of remaining charge of his hearing aid. A message conveying information to a user on the screen of the telephone may comprise simple logos. As a variant, the human-machine interface of the telephone may use the voice synthesis functionality of the telephone and transmit sound messages to its user, for example to transmit data to him from the hearing aid.

Naturally, the battery recharging device of the telephone may also be used outside of a telephone call, and by removing the hearing aid from the ear of its wearer. A wearer may choose to complete the charging of his hearing aid independently, for example in periods during which he has not used the telephone enough to obtain a sufficient charge for his hearing aid. Thus, the telephone is suitable for recharging the hearing aid in any situation, which avoids the need to have another charger dedicated to the hearing aid. To implement such a charge, a hearing aid wearer may remove his hearing aid, position it on a charging placement 14 provided on this telephone, as is represented in FIGS. 3 and 4, in the middle of the antenna of its resonant circuit dedicated to charging. Then, he manually activates a charging of the battery of the hearing aid via a dedicated human-machine interface. As a variant, this charging may be triggered automatically when the hearing aid is placed on a screen of the telephone, which the latter detects automatically.

FIG. 5 thus summarizes the various initial steps of a method for the contactless charging of the battery of a portable object according to one embodiment.

In a first step E1, the mobile telephone determines whether it is not already in a battery charging mode and whether it is in proximity to a portable object. This may be determined from a proximity sensor, such as an infrared sensor or a sensor of the “touch sensing” type, for example.

If the response to the first step E1 is positive, the charging device of the mobile telephone then emits an electromagnetic field according to a second step E2.

In a third step E3, a charge authorization may be implemented, to avoid unlimited communications between all the telephones and all the portable objects, in the interests of safety. For this, the telephone may have, in a memory, identifiers of portable objects for which it is authorized to implement the charging of their battery, and a data communication. The portable object therefore transfers its identifier to the telephone, via the contactless link, which either recognizes it or does not. If the authentication is positive, then the communication between the portable object and the telephone is possible. Otherwise, the process is interrupted. As a variant, or in addition, each portable object may also reciprocally identify the telephone in proximity and determine whether it is authorized or not to implement the charging of its battery and to communicate.

In a fourth step E4, the telephone asks its user, through the intermediary of a human-machine interface via its screen 13 and/or an interface of sound type, which service is desired. According to the embodiment represented, the user has the choice between a first battery charging mode and a second mode for informing on the state of residual charge of the battery.

If the first mode is selected by the user, the telephone begins the charging of the battery of the portable object, in a step E5. It should be noted that the selection of the user triggers an action on the part of the telephone and within the portable object, a central processing unit of which locally manages the charging of the battery from the contactless power supply induced by the electromagnetic field created by the telephone. The charging mode of the telephone may be displayed by a message 38 on its screen 13, as is represented in FIG. 4.

If the second mode is selected by the user, the telephone displays the charge of the battery of the portable object, in a step E6, after the transmission of this information via the contactless link from the portable object to the telephone.

It is to be appreciated that the steps of method may be performed sequentially, in parallel, omitted or in an order different from the order that is illustrated.

The telephone 10 equipped in this way with a contactless battery charging device is suitable for charging the battery of many portable objects, and not exclusively for a hearing aid. Thus, such a telephone offers the advantage of reducing the total number of battery chargers needed, dedicated to a single object. Since the telephone is an object that is widely used and often kept close by or even about his person by a user, the evolution of the telephone to a universal battery charger immediately appears to be a very useful solution. It will be accessible most of time if there is a desire to charge a certain portable object. In particular, the telephone can thus charge the battery of accessories such as a Bluetooth earpiece, a computer mouse, a GPS, a personal digital assistant (PDA), and so on. Thus, the solution retained also relates to a system comprising a telephone equipped with a battery charging device and at least two distinct portable objects, of different kinds, that is to say fulfilling different functionalities, which are suited to a charging of their battery by this same telephone according to the principles explained previously. Such a telephone thus fulfils the multi-purpose charger, or universal charger, function.

Naturally, this charging function added to a telephone, which may be a telephone with several functions, often called “smart phone”, is compatible with numerous other functions already present on a telephone, such as the PDA, camera, video camera, contact list and other such functions. Thus, this charging function can be added to any mobile appliance, such as a personal digital assistant or a tablet, and in particular to any telephone. The latter can therefore fully manage all of the method for charging and communicating with a portable object, using a dedicated human-machine interface. As a variant, all or part of this management may be transferred to the portable object, which also has software and/or hardware, such as a computer, enabling it to share this management and notably handle a local control of the charging method relating to its battery. For example, it may have a human-machine interface enabling its user to select the desired operations on the portable object, and not on the telephone.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method for charging a battery of a portable object, the method comprising:
contactlessly transmitting energy from a charging device of a telephone to the portable object; and
in response to the portable object being exposed to the energy, inducing a charging of the battery of the portable object.

2. The method according to claim 1, wherein contactlessly transmitting energy comprises emitting an electromagnetic field; and
wherein inducing a charging of the battery comprises resonating a resonant circuit of the portable object to induce a charging current in the battery of the portable object.

3. The method according to claim 2, wherein the electromagnetic field is emitted at a frequency of between approximately 10 MHz and approximately 15 MHz.

4. The method according to claim 1, wherein the electromagnetic field is emitted while the telephone is in use.

5. The method according to claim 4, wherein the electromagnetic field is emitted while the telephone is receiving signals corresponding to sound.

6. The method according to claim 1, further comprising contactlessly exchanging data between the portable object and the telephone via the charging device of the telephone.

7. The method according to claim 6, wherein contactlessly exchanging data comprises at least one of the following:
transmitting, from the portable object to the telephone, data that corresponds to a state of charge of the battery of the portable object;
transmitting, from the portable object to the telephone, data that corresponds to a state of health of the battery of the portable object;
transmitting, from the portable object to the telephone, data that corresponds to an operation of the portable object; and
transmitting, from the telephone to the portable object, parameters for setting an operation of the portable object.

8. The method according to claim 7, further comprising displaying on a screen of the telephone at least one of the following:
a state of charge of the battery of the portable object;
a state of health of the battery of the portable object;
a datum representing an operation of the portable object;
a parameter for setting an operation of the portable object; and
an operating mode of the telephone.

9. The method according to claim 1, wherein the portable object is a hearing aid, the method further comprising:
determining whether the hearing aid is within a proximity of telephone;
increasing the sound volume of the telephone and reducing the amplification of sound incoming to the hearing aid; and
if the hearing aid is within proximity of the telephone, contactlessly transmitting energy from the charging device of the telephone.

10. A telephone comprising:
a wireless device configured to transmit and receive signals during a telephone call;
a computing device; and
a battery charging device coupled to the computing device, the battery charging device being configured to contactlessly transmit energy from the telephone to charge a battery of a portable object.

11. The telephone according to claim 10, wherein the battery charging device includes a resonant circuit having an antenna.

12. The telephone according to claim 11, wherein the antenna of the resonant circuit of the battery charging device occupies more than half of a surface area of the telephone.

13. The telephone according to claim 12, further comprising a screen, the antenna of the resonant circuit of the battery charging device being incorporated in the screen of the telephone.

14. The telephone according to claim 12, wherein the resonant frequency of the resonant circuit of the battery charging device is between approximately 10 MHz and 15 MHz.

15. The telephone according to claim 12, wherein the resonant circuit of the battery charging device is configured to contactlessly transmit energy at a distance less than or equal to 10 centimeters.

16. The telephone according to claim 12, further comprising a proximity sensor configured to sense whether the portable object is within a distance of the telephone.

17. The telephone according to claim 11, wherein the resonant circuit of the battery charging device is configured to exchange data with the portable object.

18. The telephone according to claim 10, further comprising a user interface coupled to the computing device, the computing device being configured to communicate data with the portable object in response to data inputs received from the user interface.

19. The telephone according to claim 18, wherein the user interface is configured to select a mode for managing charging of the battery of the portable object.

20. A system comprising:
a telephone having a wireless device configured to transmit and receive signals during a telephone call, the telephone including a battery charging device configured to emit an electromagnetic field; and
a portable object having a resonant circuit coupled to a battery, the resonant circuit being configured to resonate at a resonant frequency in response to being exposed to the electromagnetic field to induce current in the battery to cause the charging of the battery.

21. The system of claim 20, wherein the portable object is a hearing aid.

22. The system of claim 20, wherein the battery charging device includes a telephone resonant circuit configured to emit the electromagnetic field by resonating at a frequency that substantially corresponds to the resonant frequency of the resonant circuit of the portable object.

23. The system of claim 20, wherein the portable object is a first portable object and the resonant circuit is a first resonant circuit, the system further comprising a second portable object having a second resonant circuit coupled to a battery, the second resonant circuit being configured to resonate in response to being exposed to the electromagnetic field to induce current in the battery to cause the charging of the battery.
